(19) United States
(12) Patent Application Publication
(10) Pub. No.: US 2026/0237904 A1
(43) Pub. Date: Aug. 13, 2026

(54) ANTENNA STRUCTURE AND FORMING METHOD THEREOF

(71) Applicant: WNC Corporation, Hsinchu (TW)

(72) Inventors: Yi-Chieh LIN, Hsinchu (TW); Jing Wen CHEN, Hsinchu (TW)

(21) Appl. No.: 19/430,387

(22) Filed: Dec. 23, 2025

(30) Foreign Application Priority Data
Feb. 11, 2025 (TW) 114105084

(51) Int. Cl. H01Q 9/04; B32B 3/26; B32B 7/12; B32B 15/09

(52) U.S. Cl. CPC H01Q 9/0407; B32B 3/266; B32B 7/12; B32B 15/09; B32B 2307/584; B32B 2307/7376; B32B 2457/00

(57) ABSTRACT

An antenna structure includes a substrate, an antenna unit and a first protection portion. The substrate has a first surface. The antenna unit is disposed on the first surface and includes a metal pattern layer and a glue layer. The glue layer is configured to adhere the metal pattern layer to the first surface. The first protection portion is disposed on the metal pattern layer and includes a first protection layer and a first glue layer. The first protection layer includes at least one feeding hole. The first glue layer is configured to adhere the first protection layer to the metal pattern layer.

### RELATED APPLICATIONS

This application claims the benefit of priority to Taiwan Patent Application No. 114105084, filed on February 11, 2025. The entire content of the above identified application is incorporated herein by reference.

### BACKGROUND

### Technical Field

The present disclosure relates to an antenna structure and a method for forming the same.

### Description of Related Art

With the increasing global emphasis and promotion of Environmental, Social, and Governance (ESG), product design and manufacturing processes must prioritize environmental friendliness and reduction of carbon footprint.

However, current antenna designs are mostly implemented using traditional Printed Circuit Board (PCB) technology. The PCB manufacturing process involves chemical etching, which not only entails complex procedures and high resource consumption, but also generates a large amount of harmful chemicals, thereby causing a certain degree of environmental pollution.

Moreover, PCB manufacturing typically utilizes brushing or coating-type thermosetting adhesives (such as UV adhesives), which require additional glue dispensing equipment, thereby significantly increasing manufacturing cost and complexity. In addition, thermosetting adhesives are difficult to handle during recycling and disassembly, reducing the ease of environmental recovery.

Furthermore, current antenna designs are limited to passive antennas and cannot be applied to higher-performance active antennas, thus restricting the application scope and market value of antennas.

Accordingly, there is a lack in the market of an antenna structure and forming method that combines environmental friendliness, high efficiency, and low manufacturing cost, and thus, industry stakeholders are actively seeking solutions to address this issue.

### SUMMARY

According to one aspect of the present disclosure, an antenna structure is provided. The antenna structure includes a substrate, an antenna unit, and a first protection portion. The substrate has a first surface. The antenna unit is disposed on the first surface and includes a metal pattern layer and a glue layer. The glue layer is configured to adhere the metal pattern layer to the first surface. The first protection portion is disposed on the metal pattern layer and includes a first protection layer and a first glue layer. The first protection layer has at least one feeding hole. The first glue layer is configured to adhere the first protection layer to the metal pattern layer. A thickness of the substrate ranges from 0.2 mm to 0.8 mm.

According to another aspect of the present disclosure, an antenna structure forming method is provided, which includes: pattern-cutting a metal with a circular knife to form a metal pattern layer. Laminating the metal pattern layer and a glue layer with a rolling device and applying heat to form an antenna unit, and laminating a first protection layer and a first glue layer and applying heat to form a first protection portion. The first protection layer includes at least one feeding hole. Laminating a substrate, the antenna unit, and the first protection portion with the rolling device and applying heat so that the antenna unit is adhered to a first surface of the substrate, and the first protection portion is adhered to the metal pattern layer of the antenna unit, thereby forming an antenna structure. A thickness of the substrate ranges from 0.2 mm to 0.8 mm.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of an antenna structure according to a first embodiment of the present disclosure.

FIG. 2 is a schematic diagram of the feeding holes of a first protection layer shown in FIG. 1.

FIG. 3 is a block flow diagram of an antenna structure forming method according to a second embodiment of the present disclosure.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

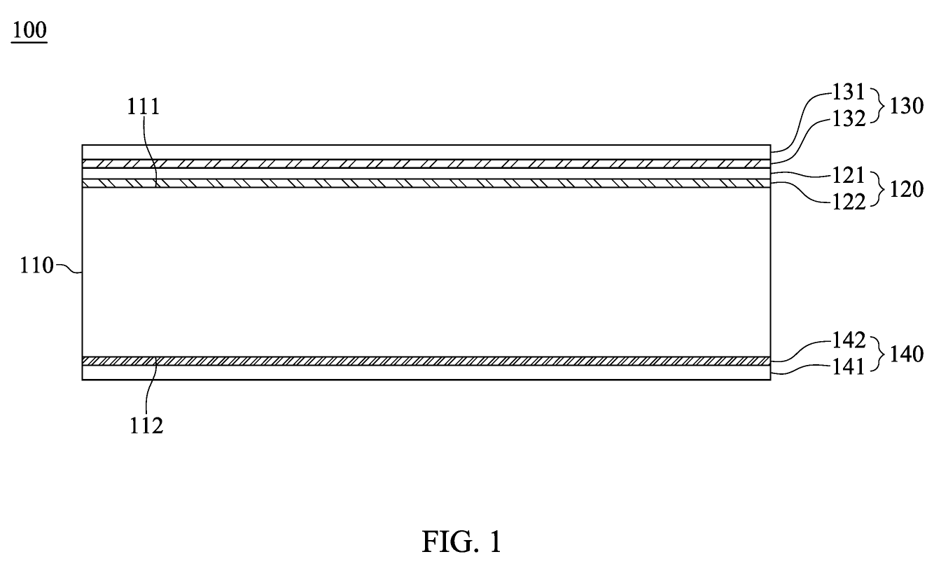

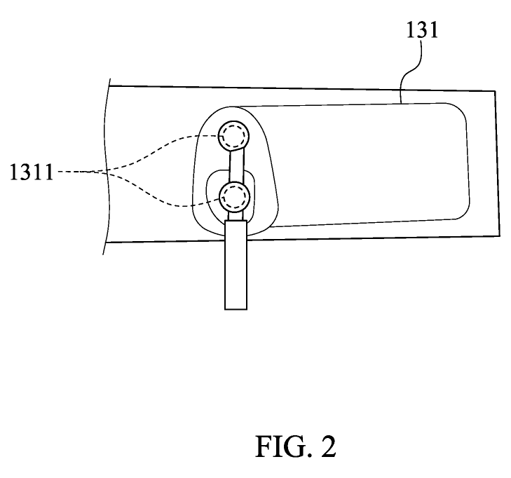

Please refer to FIG. 1 and FIG. 2 together. FIG. 1 is a schematic diagram of the antenna structure 100 according to a first embodiment of the present disclosure, and FIG. 2 is a schematic diagram of the feeding holes 1311 of a first protection layer 131 shown in FIG. 1. The antenna structure 100 includes a substrate 110, an antenna unit 120, and a first protection portion 130. The antenna unit 120 is disposed on one side of the substrate 110, and the first protection portion 130 is disposed on a side of the antenna unit 120 opposite to the substrate 110. The antenna unit 120 is located between the first protection portion 130 and the substrate 110.

The substrate 110 has a first surface 111 and a second surface 112. The second surface 112 is disposed opposite to the first surface 111. In the first embodiment, a thickness of the substrate 110 ranges from 0.2 mm to 0.8 mm, although the present disclosure is not limited thereto.

The material of the substrate 110 can be flexibly selected according to the dielectric constant requirements of the frequency band of the antenna unit 120. In the first embodiment, the substrate 110 may be made of polyethylene terephthalate (PET), polyimide (PI), or FR4 glass fiber reinforced epoxy resin, although the present disclosure is not limited thereto.

The antenna unit 120 is disposed on the first surface 111 and includes a metal pattern layer 121 and a glue layer 122. The metal pattern layer 121 serves as an antenna branch (not separately illustrated), and the antenna branch has at least one feeding point. In the first embodiment, the metal pattern layer 121 may be formed of rolled and annealed (RA) copper foil, although the present disclosure is not limited thereto.

The glue layer 122 is configured to adhere the metal pattern layer 121 to the first surface 111. In the first embodiment, a thickness of the glue layer 122 ranges from 0.02 mm to 0.04 mm. The glue layer 122 may be a hot-melt adhesive layer made of thermoplastic polyurethane (TPU) and may be in the form of a black film, although the present disclosure is not limited thereto.

The first protection portion 130 is disposed on the metal pattern layer 121 and includes a first protection layer 131 and a first glue layer 132. The first protection layer 131 is configured to cover and protect the metal pattern layer 121 of the antenna unit 120. The first protection layer 131 has at least one feeding hole 1311, which corresponds to at least one feeding point of the antenna branch of the metal pattern layer 121 (not illustrated).

As shown in FIG. 2, in the first embodiment, a number of the at least one feeding hole 1311 is two, and a number of feeding points of the antenna branch is also two. The two feeding holes 1311 correspond to the two feeding points of the antenna branch, respectively. As a result, the design requirements of active antennas are satisfied, expanding the application scope from passive antennas to active antennas and enhancing design flexibility and market value.

In addition, in the first embodiment, a thickness of the first protection layer 131 ranges from 0.04 mm to 0.06 mm. The first protection layer 131 may be made of either PET or PI, although the present disclosure is not limited thereto.

It is particularly noted that when PI material is selected for the first protection layer 131, it can better provide additional protection to the metal pattern layer 121 in cases where the feeding points of the antenna unit 120 are extended by welding, thereby preventing external damage to the antenna structure 100.

The first glue layer 132 is configured to adhere the first protection layer 131 to the metal pattern layer 121. In the first embodiment, a thickness of the first glue layer 132 ranges from 0.02 mm to 0.04 mm. The first glue layer 132 is a hot-melt adhesive layer made of TPU, although the present disclosure is not limited thereto.

Additionally, the antenna structure 100 may further include a second protection portion 140, which is disposed on the second surface 112 of the substrate 110. The second protection portion 140 includes a second protection layer 141 and a second glue layer 142.

The second protection layer 141 is configured to cover and protect the substrate 110. In the first embodiment, a thickness of the second protection layer 141 ranges from 0.04 mm to 0.06 mm. The second protection layer 141 may be made of either PET or PI, although the present disclosure is not limited thereto.

The second glue layer 142 is configured to adhere the second protection layer 141 to the second surface 112. In the first embodiment, a thickness of the second glue layer 142 ranges from 0.02 mm to 0.04 mm. The second glue layer 142 is a hot-melt adhesive layer made of TPU, although the present disclosure is not limited thereto.

It is noted that the glue layer 122, the first glue layer 132, and the second glue layer 142 are all formed by cutting hot-melt adhesive sheets with a circular knife. These layers have a hot-melt temperature ranging from 120°C to 130°C and can be subjected to a pressure of 1 to 3 kilograms to enhance adhesion. A servo pressing method may be used for pressure application, which provides more stable control compared to pneumatic pressing. By heating the glue layer 122, the first glue layer 132, and the second glue layer 142 to the hot-melt temperature, excellent adhesion can be achieved, thereby effectively bonding the first protection layer 131, the metal pattern layer 121, the substrate 110, and the second protection layer 141, and enhancing the structural stability.

As a result, the use of UV adhesive bonding can be replaced, eliminating the need for glue dispensing equipment, ultraviolet curing equipment, and baking equipment. This simplifies the process, reduces manufacturing costs, and facilitates disassembly, thereby promoting material recycling.

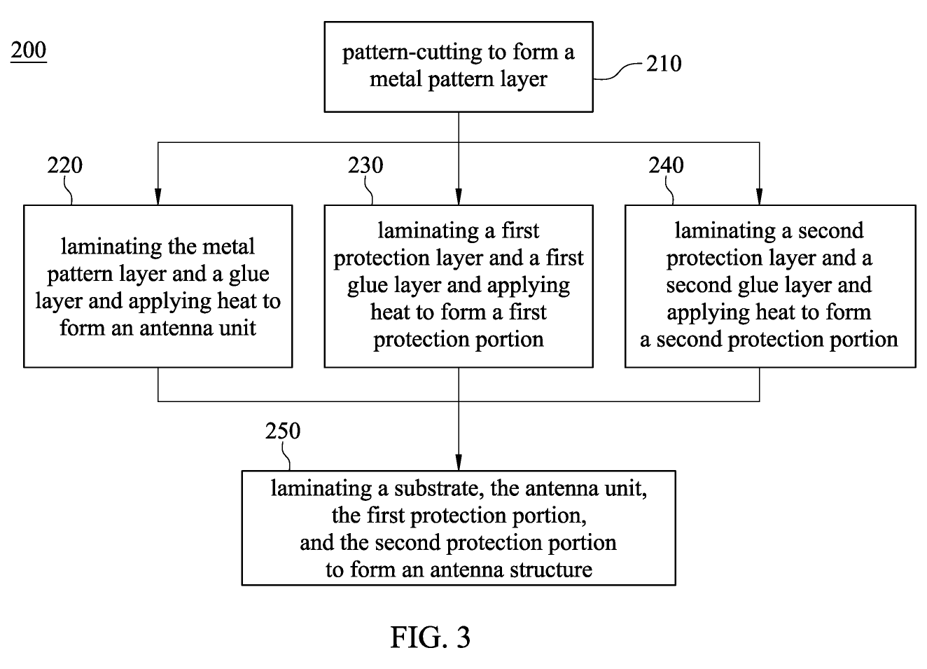

The following description explains the antenna structure forming method 200 provided in the present disclosure. Please refer to FIGS. 1 to 3 together, where FIG. 3 is a block flow diagram of an antenna structure forming method 200 according to a second embodiment of the present disclosure. It should be noted that the antenna structure 100 of the present disclosure is not limited to being manufactured by the antenna structure forming method 200. The antenna structure forming method 200 includes step 210, step 220, step 230, step 240, and step 250. Steps 220, 230, and 240 are performed between step 210 and step 250, and may be performed simultaneously or in any order, not limited to the sequence described herein.

Step 210 includes pattern-cutting a metal with a circular knife through a flexible die-cutting process to form a metal pattern layer 121. The metal pattern layer 121 serves as an antenna branch. Step 220 includes laminating the metal pattern layer 121 and a glue layer 122 with a rolling device, and applying heat to form an antenna unit 120.

Step 230 includes laminating a first protection layer 131 and a first glue layer 132 with the rolling device and applying heat to form a first protection portion 130. The first protection layer 131 includes at least one feeding hole 1311, which corresponds to at least one feeding point of the antenna branch of the metal pattern layer 121. Step 240 includes laminating a second protection layer 141 and a second glue layer 142 with the rolling device and applying heat to form a second protection portion 140.

Step 250 includes laminating the substrate 110, the antenna unit 120, the first protection portion 130, and the second protection portion 140 with the rolling device and applying heat, so that the antenna unit 120 is adhered to a first surface 111 of the substrate 110, and the first protection portion 130 is adhered to the metal pattern layer 121 of the antenna unit 120, and the second protection portion 140 is adhered to the second surface 112 of the substrate 110 opposite to the first surface 111, thereby forming the antenna structure 100.

In the second embodiment, the number of the at least one feeding hole 1311 is two (as shown in FIG. 2). During step 250, when the rolling device laminates the antenna unit 120 and the first protection portion 130, the two feeding holes 1311 are respectively aligned with the two feeding points of the antenna branch.

Furthermore, it should be noted that the sequence in which the rolling device laminates the substrate 110, the antenna unit 120, the first protection portion 130, and the second protection portion 140 may be configured as needed in the rolling device. In the second embodiment, the rolling device first bonds the antenna unit 120 to the first surface 111 of the substrate 110. Then, the first protection portion 130 is bonded to the antenna unit 120. Finally, the second protection portion 140 is bonded to the second surface 112 of the substrate 110 to form the antenna structure 100, although the present disclosure is not limited thereto.

In other possible embodiments, the rolling device may first bond the second protection portion to the second surface of the substrate. Then, the antenna unit and the first protection portion are combined. Finally, the antenna unit and the first protection portion are together bonded to the first surface of the substrate to form the antenna structure.

Moreover, the glue layer 122, the first glue layer 132, and the second glue layer 142 are all formed by cutting hot-melt adhesive sheets with a circular knife. In steps 220, 230, 240, and 250, the rolling device is heated to a hot-melt temperature to soften the glue layer 122, the first glue layer 132, and the second glue layer 142, and the hot-melt temperature ranges from 120°C to 130°C.

As a result, excellent adhesion can be provided, thereby effectively bonding the first protection layer 131, the metal pattern layer 121, the substrate 110, and the second protection layer 141, thus enhancing the structural stability.

From the above embodiments, the present disclosure has the following advantages: (1) By heating the glue layer, the first glue layer, and the second glue layer to the hot-melt temperature, excellent adhesion is achieved, which not only improves the structural stability of the antenna structure but also replaces UV adhesive bonding and eliminates the need for glue dispensing, UV, and baking equipment, thereby simplifying the process and reducing manufacturing cost. (2) By using flexible die-cutting processes and hot-melt adhesives to laminate the layers into an antenna structure, no large amount of harmful substances is produced during fabrication, and disassembly is easier, which facilitates material recycling and achieves environmental benefits. (3) By forming feeding holes in the first protection layer, the design requirements for active antennas are met, expanding the application scope from passive antennas to active antennas and enhancing design flexibility and market applicability.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An antenna structure, comprising:
a substrate having a first surface;
an antenna unit disposed on the first surface, the antenna unit comprising:
a metal pattern layer; and
a glue layer configured to adhere the metal pattern layer to the first surface; and
a first protection portion disposed on the metal pattern layer, the first protection portion comprising:
a first protection layer having at least one feeding hole; and
a first glue layer configured to adhere the first protection layer to the metal pattern layer;
wherein a thickness of the substrate ranges from 0.2 mm to 0.8 mm.

2. The antenna structure of claim 1, further comprising:
a second protection portion disposed on a second surface of the substrate opposite the first surface, the second protection portion comprising:
a second protection layer; and
a second glue layer configured to adhere the second protection layer to the second surface.

3. The antenna structure of claim 2, wherein the first protection layer is made of either polyethylene terephthalate or polyimide, and the second protection layer is made of either polyethylene terephthalate or polyimide.

4. The antenna structure of claim 2, wherein a thickness of the first protection layer ranges from 0.04 mm to 0.06 mm, and a thickness of the second protection layer ranges from 0.04 mm to 0.06 mm.

5. The antenna structure of claim 2, wherein the glue layer, the first glue layer, and the second glue layer are all hot-melt adhesive layers made of polyurethane.

6. The antenna structure of claim 5, wherein the hot-melt adhesive layer has a hot-melt temperature ranging from 120°C to 130°C.

7. The antenna structure of claim 2, wherein a thickness of the glue layer ranges from 0.02 mm to 0.04 mm, a thickness of the first glue layer ranges from 0.02 mm to 0.04 mm, and a thickness of the second glue layer ranges from 0.02 mm to 0.04 mm.

8. The antenna structure of claim 1, wherein the substrate is made of one of polyethylene terephthalate, polyimide, or glass fiber reinforced epoxy resin.

9. The antenna structure of claim 1, wherein the metal pattern layer serves as an antenna branch, a number of the at least one feeding hole is two, and the two feeding holes respectively correspond to two feeding points of the antenna branch.

10. An antenna structure forming method, comprising:
pattern-cutting a metal with a circular knife to form a metal pattern layer;
laminating the metal pattern layer and a glue layer with a rolling device and applying heat to form an antenna unit, and laminating a first protection layer and a first glue layer and applying heat to form a first protection portion, wherein the first protection layer comprises at least one feeding hole; and
laminating a substrate, the antenna unit, and the first protection portion with the rolling device and applying heat, so that the antenna unit is adhered to a first surface of the substrate, and the first protection portion is adhered to the metal pattern layer of the antenna unit, thereby forming an antenna structure;
wherein a thickness of the substrate ranges from 0.2 mm to 0.8 mm.

11. The antenna structure forming method of claim 10, further comprising:
laminating a second protection layer and a second glue layer with the rolling device and applying heat to form a second protection portion.

12. The antenna structure forming method of claim 11, further comprising:
laminating the substrate, the antenna unit, the first protection portion, and the second protection portion with the rolling device and applying heat to adhere the second protection portion to a second surface of the substrate opposite the first surface.

13. The antenna structure forming method of claim 11, wherein a thickness of the first protection layer ranges from 0.04 mm to 0.06 mm, and a thickness of the second protection layer ranges from 0.04 mm to 0.06 mm.

14. The antenna structure forming method of claim 11, wherein the glue layer, the first glue layer, and the second glue layer are all hot-melt adhesive layers made of polyurethane.

15. The antenna structure forming method of claim 14, wherein the rolling device is heated to a hot-melt temperature to soften the glue layer, the first glue layer, and the second glue layer, and the hot-melt temperature ranges from 120°C to 130°C.

16. The antenna structure forming method of claim 11, wherein a thickness of the glue layer ranges from 0.02 mm to 0.04 mm, a thickness of the first glue layer ranges from 0.02 mm to 0.04 mm, and a thickness of the second glue layer ranges from 0.02 mm to 0.04 mm.

17. The antenna structure forming method of claim 10, wherein the metal pattern layer serves as an antenna branch, a number of the at least one feeding hole is two, and when the rolling device laminates the antenna unit and the first protection portion, the two feeding holes respectively correspond to two feeding points of the antenna branch.
